(19) United States
(12) Patent Application Publication
(10) Pub. No.: US 2009/0066005 A1
(43) Pub. Date: Mar. 12, 2009

(54) Methods for Determining Widths Of Media Sheets Within An Image Forming Apparatus

(76) Inventors: Thomas Paul Maddux, Lexington, KY (US); Clark Edwin Jarnagin, Lexington, KY (US); Daniel P. Cahill, Verona, KY (US); Kevin D. Schoedinger, Lexington, KY (US); David John Mickan, Lexington, KY (US)

Correspondence Address: John J. McArdle, Jr.;Lexmark International, Inc., Intellectual Property Department, 740 West New Circle Road, Lexington, KY, 40550, US

(21) Appl. No.: 11/851,836

(22) Filed: Sep. 7, 2007

(51) Int. Cl. B65H 7/02; G03G 21/00

(52) U.S. Cl. 271/3.13

(57) ABSTRACT

The present application is directed to methods of determining a width of a media sheet moving along a media path of an image forming apparatus. The methods may include moving the media sheet along the media path and past a media width sensor that includes a shaft with a first upstream paddle positioned away from a reference location of the media path and a second downstream paddle positioned in closer proximity to the reference location. The first paddle is positioned a first distance from the first sensor, and the second paddle is positioned a second distance from the first sensor. As the media sheet moves along the media path, a first signal may be received when the media sheet contacts the first sensor, and a second signal when the media sheet is at the media width sensor. The distance the media sheet travels between contacting the first sensor and being at the second sensor may be determined. The method may also determine whether the media sheet contacted the first or second paddle based on the media sheet travel distance. Based on which paddle was contacted, it may then be determined whether the media sheet is wide or intermediate. The method may also include determining the media sheet is narrow if there is no receipt of two signals.

### BACKGROUND

The present application relates generally to the field of image forming apparatus, and in particular, to methods of determining the width of a media sheet as it moves along a media path within the image forming apparatus.

Image forming apparatus move a media sheet through an extended media path. The media sheet undergoes numerous image forming operations along the path such as initial input into the media path from an input tray or exterior input, image transfer area, and adhering the image to the media sheet.

In an image forming apparatus with a fusing area, narrow media sheets moving through the fusing area may cause uneven heating of the fusing members. The uneven heating occurs between a first section of the fusing members that are contacted by the media sheets, and a second section that is not contacted by the media sheets. The first section maintains a first temperature range, while the second section maintains a second, higher temperature range. This uneven heating of the fusing members may result in inadequate fusing of the toner to the media sheets. The unequal heating may also decrease the life and reliability of the fusing members.

Another area affected by the width of the media sheets is the image transfer area. This area should be configured to prevent transfer of the image at a point off of the media sheet. This is especially evident when the media sheets are aligned to a particular reference location along the media path.

### SUMMARY

The present application is directed to methods of determining a width of a media sheet moving along a media path of an image forming apparatus. The methods may include moving the media sheet along the media path and past a media width sensor that includes a shaft with a first upstream paddle positioned away from a reference location of the media path and a second downstream paddle positioned in closer proximity to the reference location. The first paddle may be positioned a first distance from the first sensor, and the second paddle may be positioned a second distance from the first sensor. As the media sheet moves along the media path, a first signal may be received when the media sheet contacts the first sensor, and a second signal when the media sheet is at the media width sensor. The distance the media sheet travels between contacting the first sensor and being at the second sensor may be determined. The method may also determine whether the media sheet contacted the first or second paddle based on the media sheet travel distance. Based on which paddle was contacted, it may then be determined whether the media sheet is wide or intermediate. The method may also include determining the media sheet is narrow if there is no receipt of two signals.

### BRIEF DESCRIPTION OF THE DRAWINGS

FIG. 1 is a schematic view of a media width sensor positioned along a media path of an image forming apparatus according to one embodiment.

FIG. 2 is a perspective view of a media width sensor according to one embodiment.

FIG. 3 is a side view of a media width sensor according to one embodiment.

FIG. 4 is a flowchart diagram of steps of determining a media sheet width according to one embodiment.

FIG. 5 is a flowchart diagram of steps of determining a media sheet width according to one embodiment.

FIG. 6 is a flowchart diagram of steps of determining a media sheet width according to one embodiment.

FIG. 7 is a partial perspective view of an arm and paddles of a media width sensor according to one embodiment.

FIG. 8 is a perspective view of a media width sensor according to one embodiment.

### DETAILED DESCRIPTION

The present application is directed to methods of determining a width of a media sheet as it moves along a media path within an image forming apparatus. The methods may include a media width sensor that includes first and second paddles that extend into the media path. The paddles are arranged with one paddle being positioned upstream from the other paddle. The paddles are also arranged with one paddle in closer proximity to a reference location on the media path than the second paddle. This arrangement causes media sheets of a first width to contact the first paddle, media sheets of a second width to contact the second paddle, and media sheets of a narrower third width to contact neither paddle. A second sensor is positioned along the media path and positioned a first distance away from the first paddle and a second distance away from the second paddle. The width of the media sheet is determined based on the interaction of the media sheet with the media width sensor and the second sensor.

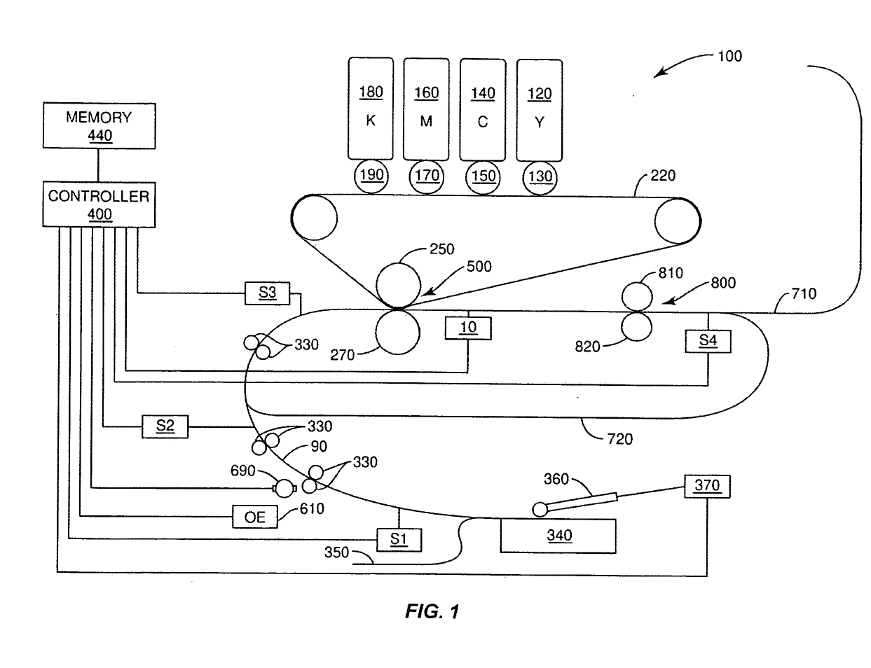

The media width sensor 10 is used in a plurality of different image forming apparatus, such as the apparatus 100 illustrated in FIG. 1. Apparatus 100 includes a plurality of toner cartridges 120, 140, 160, 180 each having a corresponding photoconductive drum 130, 150, 170, 190. Each toner cartridge has a similar construction but is distinguished by the toner color contained therein. In one embodiment, the apparatus 100 includes a black cartridge 180, a magenta cartridge 160, a cyan cartridge 140, and a yellow cartridge 120. The different color toners form individual images in their respective color that are combined in layered fashion to create the final multicolored image.

Each photoconductive drum 130, 150, 170, 190 has a smooth surface for receiving an electrostatic charge from a laser assembly (not illustrated). The drums continuously and uniformly rotate past the laser assembly that directs a laser beam onto selected portions of the drum surfaces forming an electrostatic latent image representing the image to be printed. The drum is rotated as the laser beam is scanned across its length. This process continues as the entire image is formed on the drum surface. After receiving the latent image, the drums rotate past a toner area having a toner bin for housing the toner and a developer roller for uniformly transferring toner to the drum. The toner is attracted to the electrostatic latent image formed on the drum surface by the laser assembly.

An intermediate transfer medium (ITM) belt 220 is positioned to receive the toner images from each drum surface. The ITM belt 220 is endless and extends around a series of rollers adjacent to the drums 130, 150, 170, 190. The ITM belt 220 and drums 130, 150, 170, 190 are synchronized providing for the toner image from each drum to precisely align in an overlapping arrangement. In one embodiment, a multi-color toner image is formed during a single pass of the ITM belt 220. By way of example as viewed in FIG. 1, the yellow (Y) toner is placed first on the ITM belt 220, followed by cyan (C), magenta (M), and black (K). In one embodiment, ITM belt 220 makes a plurality of passes by the drums to form the overlapping toner image.

ITM belt 220 moves the toner image towards a second transfer point 500 where the toner images are transferred to a media sheet. A pair of rollers 250, 270 forms a nip where the toner images are transferred from the ITM belt 220 to the media sheet. The media sheet with toner image then travels through a fuser 800 comprised of fuser members 810, 820 where the toner is adhered to the media sheet. The media sheet with fused image is then either outputted to an output tray 710, or routed through a duplex path 720 for image formation on a second side.

A media path 90 includes a series of nip rollers 330 spaced a distance apart and rotated to control the speed and position of each media sheet. One or more sensors S1, S2, S3, etc. may be placed along the paper path 90 to determine the position of the media sheet. In one embodiment, sensors S1, S2, S3, etc. are optical sensors that detect a leading edge or trailing edge of the media sheet when passing the sensor location. Rollers 330 are operated by one or more motors 690 which control the speed the media sheets move along the media path 90. The range of speeds of the rollers 330 can be adjusted by a controller 400.

Media sheets may be introduced into the media path 90 from an input tray 340 that holds a stack of media sheets, and a pick mechanism 360 for picking a topmost sheet from the stack and feeding it into the media path 90. A drive assembly 370 is controlled by controller 400 to activate the pick mechanism 360. Media sheets may also be introduced into the media path 90 through a secondary input 350 that is accessible from an exterior of the apparatus 100.

Controller 400 oversees the timing of the toner images and the media sheets to ensure the two coincide at the second transfer point 500. In one embodiment, controller 400 includes a microcontroller with associated memory 440. In one embodiment, controller 400 includes a microprocessor, random access memory, read only memory, and in input/output interface.

In one embodiment, at some designated time, pick mechanism 360 receives a command from the controller 400 to pick a media sheet. The media sheet moves through the beginning of the media path 90 and eventually trips a paper path sensor S1. Controller 400 immediately begins tracking incrementally the position of the media sheet by monitoring the feedback of encoder 610 associated with media path motor 690. Various other sensors S2, S3, etc. may be positioned along the media path 90 to further determine the location of the media sheet. Embodiments of a similar system are disclosed in U.S. Pat. No. 6,330,424 and U.S. patent application Ser. No. 10/436,406, each assigned to Lexmark International, Inc., and herein incorporated by reference.

A media width sensor 10 is positioned along the media path 90 to work in combination with one of the other sensors S1, S2, S3, etc. to determine a width of the media sheets. The sensor 10 may be positioned at various locations along the media path 90 to detect a width of the media sheets. FIG. 1 illustrates the sensor 10 positioned between the second transfer area 500 and fuser area 800. Sensor 10 may be positioned at various other locations, such as upstream from the second transfer area 500, downstream from the fuser area 800, and within the duplex path 720. In one embodiment, the sensor 10 is positioned upstream of the fuser area 800 to prevent over-heating and damage to the fusing members 810, 820. Multiple sensors 10 may also be positioned along the media path 90.

The terms “upstream” and “downstream” describe the position of elements relative to the direction of media sheet movement along the media path 90. A media sheet moving along the media path 90 will pass an upstream element prior to passing a downstream element. By way of example and using the embodiment of FIG. 1, the second transfer area 500 is upstream from the fuser area 800. The sensor 10 is downstream from second transfer area 500 and the input tray 340.

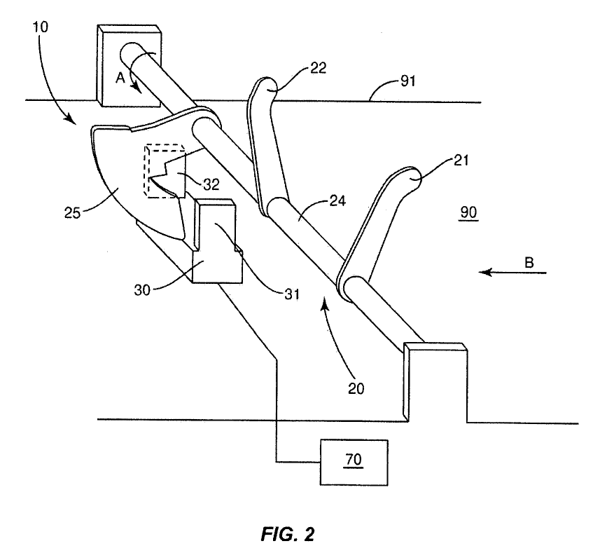

FIG. 2 illustrates one embodiment of a sensor 10 positioned along the media path 90. Sensor 10 includes an arm 20 that extends across at least a section of a media path 90. The arm 20 in FIG. 2 extends across the entire width of the media path 90, although other embodiments may include the arm 20 extending across a limited width. Arm 20 includes a shaft 24 with two or more outwardly-extending paddles 21, 22. The paddles 21, 22 are positioned at different locations along the width of the media path 90 and contact media sheets as they move along the media path 90 in the direction indicated by arrow B. Paddles 21, 22 are also positioned with paddle 21 being upstream from paddle 22. A flag 25 extends outward from the shaft 24 and travels through a detector 30 during rotation of the arm 20.

Media sheets are aligned along a reference location 91 as they move along the media path 90. The upstream paddle 21 is positioned farther away from the reference location 91 than the downstream paddle 22. A wide sheet will contact paddle 21, an intermediate sheet will contact paddle 22, and a narrow sheet will contact neither paddle 21, 22 but rather move within the gap formed between reference location 91 and paddle 22. For wide and intermediate sheets, contact with the media sheet causes the arm 20 to rotate and the flag 25 to move through the detector 30. For the narrow sheet, the arm 20 does not rotate.

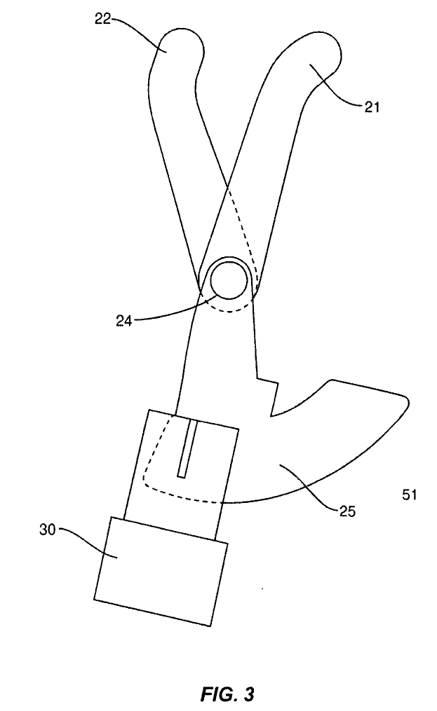

The paddles 21, 22 are axially spaced apart along the shaft 24 and positioned across the media path 90. The paddles 21, 22 are positioned a distance away from the reference location 91 that aligns the media sheets while they move along the media path 90. As illustrated in FIG. 2 and the side view of FIG. 3, paddle 21 is located upstream from paddle 22. In this embodiment, each of the paddles 21, 22 includes substantially the same shape. The paddles 21, 22 extend outward at different angular orientations causing paddle 21 to be positioned upstream from paddle 22. Further, the upstream paddle 21 is positioned a greater distance away from the reference location 91 than the downstream paddle 22.

Flag 25 extends outward from the shaft 24 at a different angular position than the paddles 21, 22. Flag 25 is positioned to move through the detector 30 during rotation of the arm 20. Flag 25 is further positioned away from the media path 90 so not interfere with movement of the media sheets.

Detector 30 includes a transmitter 31 and a receiver 32. The transmitter 31 emits a signal that is detectable by receiver 32. In one embodiment, the signal is electromagnetic energy. In one embodiment, sensor 30 is an optical sensor. Thus, transmitter 31 emits optical energy with a frequency spectrum that is detectable by receiver 32. The transmitter 31 may be embodied as an LED, laser, bulb or other source. Receiver 32 changes operating characteristics based on the presence and quantity of optical energy received. The receiver 32 may be a phototransistor, photodarlington, or other detector. The optical energy may consist of visible light or near-visible energy (e.g., infrared or ultraviolet). Further, flag 25 is positioned within the transmission path between the transmitter 31 and receiver 32. Where an optical sensor 30 is used, the flag 25 is positioned within the optical path between the transmitter 31 and receiver 32 and operates as an interrupter of sorts.

Controller 400 determines the width of the media sheets based on the distance the media sheet moves between interacting with the media width sensor 10 and a second sensor. Because the paddles 21, 22 are positioned at different locations along the media path 90, a wide media sheet moves a first distance between interacting with the media with sensor 10 by contacting paddle 21 and being at the second sensor. An intermediate sheet moves a second distance between contacting paddle 22 and being at the second sensor. Further, a narrow media sheet interacts with the media width sensor by bypassing the paddles 21, 22. Controller 400 is able to determine these differences to determine the width of the media sheet.

In one method of use with the embodiment illustrated in FIGS. 2 and 3, the media sheet moves along the media path 90 and is aligned along the reference location 91. If the media sheet is relatively wide, it will contact the paddle 21. This contact causes the arm 20 to rotate in a direction of arrow A thus causing the flag 25 to move within the detector 30 that is then signaled to the controller 400. The media sheet continues movement along the media path 90 and eventually passes beyond the arm 20. Arm 20 then rebounds to the initial position as illustrated in FIG. 2. In one embodiment, the arm 20 is weighted to return to the initial position. In another embodiment, a biasing member (not illustrated) may return the arm 20 to the initial position.

A second, intermediate media sheet moving along the media path 90 contacts paddle 22. Because of the intermediate width, the media sheet will not contact paddle 21. Contact with paddle 22 causes the arm 20 to rotate and the flag 25 to move within the transmission path between the transmitter 31 and receiver 32. This movement of the flag 25 within the detector 30 is signaled to the controller 400.

A third, narrow sheet moving along the media path 90 does not contact either paddle 21, 22. Controller 400 determines this movement and the failure to contact the paddles 21, 22 and determines the sheet is narrow.

In this embodiment, upstream paddle 21 is positioned a greater distance from the reference location 91 than downstream paddle 22. This ensures each wide and intermediate media sheet will only contact a single paddle. A wide media sheet will only contact the upstream paddle 21, and will be spaced away from the downstream paddle 22. Likewise, an intermediate media sheet will only contact the downstream paddle 22 and not the upstream paddle 21. In another embodiment, the wide and intermediate media sheets contact each of the paddles 21, 22 with the sheet initially contacting one of the paddles and then subsequently contacting the other paddle as the media sheet moves further along the media path 90.

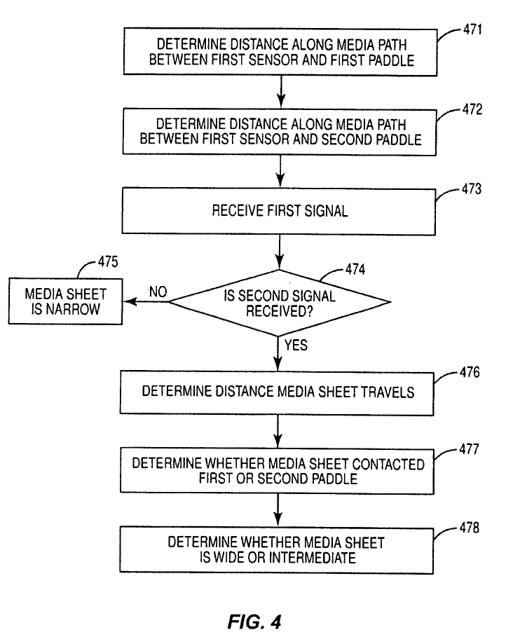

FIG. 4 illustrates the steps of one embodiment of determining a width of the media sheet. Initially, distances are determined between the first sensor and the first paddle (step 471), and between the first sensor and the second paddle (step 472). As the media sheet moves along the media path 90, the controller 400 receives a first signal (step 473). Controller 400 determines if a second signal is received (step 474). If the controller 400 does not receive a second signal, controller 400 determines that the media sheet missed the paddles and is narrow (step 475). If a second signal is received, controller 400 determines the distance traveled by the media sheet based on the timing of the signals and the known speed the media sheet was traveling along the media path 90 (step 476). This calculated distance traveled is then compared to the distances between the first sensor and the paddles. This distance is then used to determine whether the media sheet contacted the first or second paddle (step 477). The width of the media sheet may then be determined because a wide sheet contacts the first paddle and an intermediate sheet contacts the second paddle (step 478).

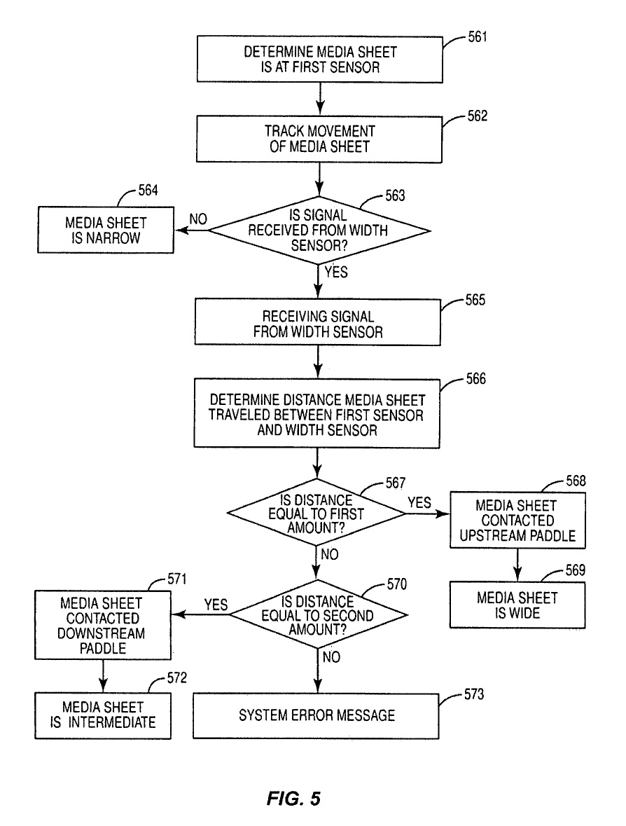

FIG. 5 illustrates one method of determining the width of a media sheet. In this embodiment, the media width sensor 10 is positioned downstream from the first sensor. In using the embodiment of FIG. 1, this may include the first sensor being either of sensors S1, S2, and S3. For purposes of this example, we will use sensor S3 as the first sensor.

Controller 400 initially determines that the media sheet is at the first sensor S3 (step 561). Controller 400 then tracks the movement of the media sheet between the first sensor S3 and the media width sensor 10 (step 562). The tracking may occur by controller 400 monitoring the feedback of encoder 610 associated with media path motor 690. Controller 400 tracks whether a signal is received from the media width sensor 10 (step 563). If no signal is received, controller 400 determines the media sheet missed the paddles 21, 22 and is therefore narrow (step 564). For non-narrow sheets, the leading edge will contact one of the paddles 21, 22 depending upon the width of the media sheet. The contact rotates the arm 20 which in turn moves the flag 25 into the detector 30 which is then signaled to the controller 400 (step 565).

Controller 400 determines the distance the media sheet moved between the first sensor S3 and the media width sensor 10 (step 566). This may be calculated based on the number of encoder pulses received during this time as the media sheet moved between sensors S3 and 10. The distance may also be calculated based on the known speed of the media sheet and the time to move between the sensors S3, 10. Various other methods may also be used to determine the distance the media sheet moved between the sensors S3, 10.

Controller 400 then compares whether the calculated amount is equal to a first predetermined distance (step 567). If the distances match, controller 400 determines that the media sheet contacted the upstream paddle 21 (step 568) and therefore the media sheet is wide (step 569). If the distances do not match, controller 400 compares whether the calculated amount is equal to a second predetermined distance (step 570). If the calculated distance is equal to the second predetermined distance, the controller 400 determines the media sheet contacted the downstream paddle 22 (step 571) and that the media sheet is intermediate (step 572).

If the calculated distance does not equal either of the first or second predetermined amounts, the controller 400 may send an error message (step 573) to a display on the exterior of the apparatus 100 instructing the user to determine whether the apparatus 100 is operating properly.

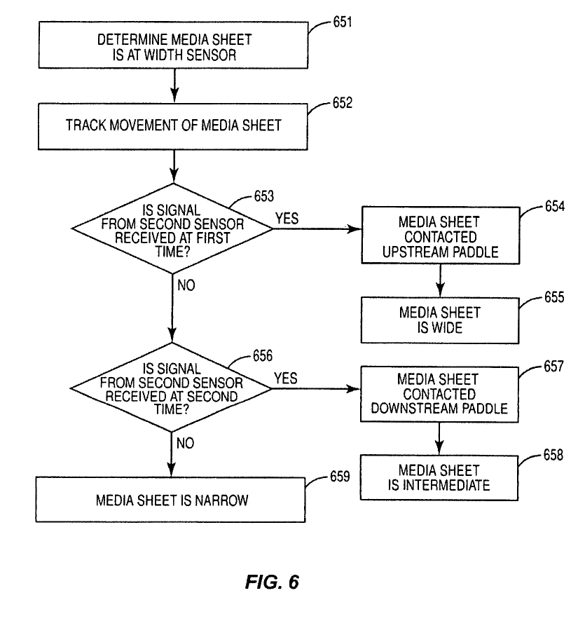

FIG. 6 includes another method with the media width sensor 10 being positioned upstream from the sensor. Using FIG. 1 again as an example, the second sensor in this embodiment is sensor S4. The method starts as the media sheet is at the media width sensor 10 (step 651). At this time, controller 400 is unaware of the width of the media sheet and which paddle 21, 22 was contacted. Controller 400 then tracks the movement of the media sheet (step 652). Controller 400 than waits to receive a signal from the downstream sensor S4 at a first time after passing the media width sensor (step 653). If a signal is received from the sensor S4 at the first predetermined time, controller 400 determines that the media sheet has moved a first distance since activating the media width sensor. Movement of the first distance is a result of the media sheet contacting the upstream paddle (step 654) and is therefore a wide media sheet (step 655).

If a signal is not received from sensor S4 at the first time, controller waits to receive a signal at a second predetermined time (step 656). If a signal is received from the sensor S4 at the second predetermined time, controller 400 determines that the media sheet has moved a second distance since activating the media width sensor 10. Movement of the second distance is a result of the media sheet contacting the downstream paddle (step 657) and is therefore an intermediate media sheet (step 658). If the only signal received is from sensor S4, controller 400 determines that the sheet is narrow (step 659) and did not trip the media width sensor.

FIGS. 2 and 3 include an embodiment with two paddles 21, 22.

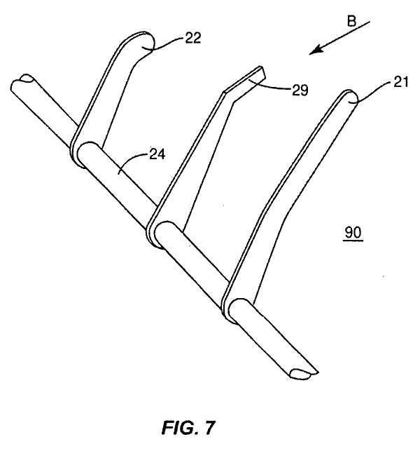

FIG. 7 illustrates another embodiment with a third paddle 29 extending outward from the shaft 24. Each of the paddles 21, 22, 29 is positioned at a different location along the media path 90 to allow detection of media sheets of four different widths. Other embodiments may further feature different numbers of paddles.

FIG. 2 also includes an embodiment with the paddles 21, 22 including substantially the same shape. FIG. 7 is an embodiment with each of the paddles 21, 22, 29 including a different shape. In this embodiment, paddle 21 includes a shape and is sized to be upstream from paddles 22 and 29. Paddle 22 includes a shape and size to be downstream of paddles 21 and 29. Paddle 29 is shaped and sized to be positioned between paddles 21 and 22. Each of the paddles 21, 22, 29 extends from the shaft 24 at substantially the same angular position with the different shapes causing the relative positioning along the media path 90.

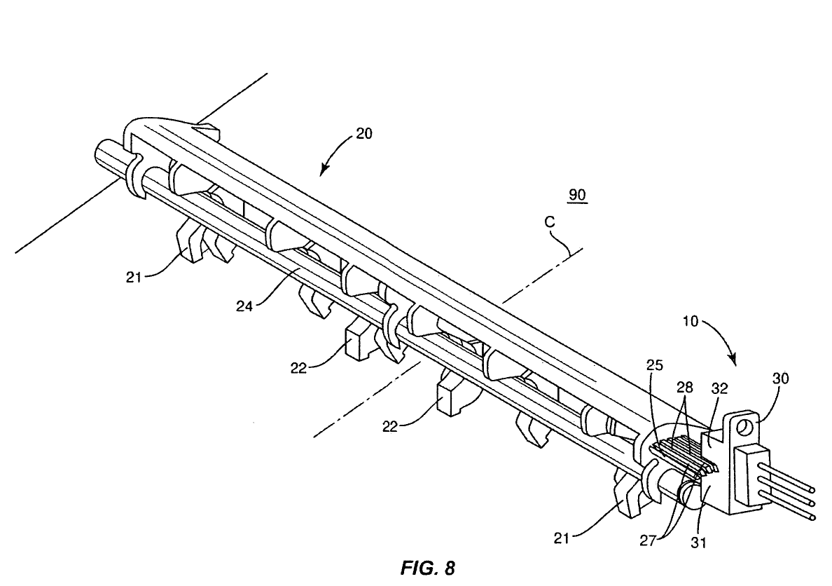

In the embodiment of FIG. 8, paddles 21, 22 each include multiple members. A first upstream paddle 21 includes two separate members that are aligned at the same position along the media path 90. A second downstream paddle 22 includes two separate members aligned at the same position. In this embodiment, each of the members of both paddles 21, 22 are symmetrically aligned relative to a center C of the media path 90. In other embodiments, paddles 21, 22 may be asymmetrically positioned along the width of the media path 90.

The embodiment of FIG. 2 illustrates an embodiment with the media sheets being reference along a reference location 91 on a lateral side of the media path 90. FIG. 8 illustrates another embodiment with the media sheets being aligned along a center C of the media path 90. The first upstream paddle 21 comprising two separate members are positioned upstream of members of paddle 22. Each of the members of paddle 21 are positioned a greater distance from the center C than the members of paddle 22. A first wide media sheet moving along the media path will contact each member of paddle 21 causing the arm 20 to rotate. Likewise, a narrow media sheet will contact each member of paddle 22. The wide media sheet will be spaced away from paddle 22, and the narrow media sheet will be spaced away from paddle 21.

In one embodiment, a window may extend through the flag 25 and move through the transmission path of the detector 30 during rotation of the arm 20. The size and shape of the window may vary depending upon the context. FIG. 8 illustrates another embodiment with the flag 25 including fingers 28 and gaps 27 that move through the detector 30.

Co-pending U.S. patent application Ser. No. ______ (Attorney Reference No. 2006-0475.02) discloses a media width sensor and is herein incorporated by reference.

The embodiment illustrated in FIG. 1 includes a color laser printer with a secondary transfer structure (i.e., the toner image is initially transferred to the ITM 220 and then at a second area 500 to the media sheet). The sensor 10 may also be used in a variety of other color laser printers, including those with direct toner transfer to the media sheet. The sensor 10 may also be used in a variety of other image forming apparatus including but not limited to mono laser printers, inkjet printers, and facsimile devices.

In the embodiments described above, the media width sensor 10 is used in combination with another sensor (e.g., S1, S2, S3, S4) positioned along the media path. In another embodiment, the controller 400 functions as the other sensor to work in combination with the media width sensor 10. Controller 400 determines the initial location of the media sheet based on the timing of the command to move the media sheet from the input tray 340. The incremental position of the media sheet as it moves along the media path 90 is tracked by pulses received by the motor encoder 610. The distance traveled by the media sheet prior to entry into the media width sensor 10 may be calculated form the input tray 340, or another predetermined location along the media path 90.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of determining a width of a media sheet moving along a media path of an image forming apparatus with a media width sensor that includes a shaft with a first paddle positioned a first distance away from a reference location of the media path and a second paddle positioned a second distance closer to the reference location, the method comprising:
receiving a reference location signal after moving the media sheet along the media path and past the reference location;
moving the media sheet along the media path and past the media width sensor;
determining the media sheet is narrow after failing to receive a media width sensor signal from the media width sensor;
receiving a media width sensor signal when the media sheet is either wide or intermediate;
determining a media sheet travel distance that the media sheet traveled between receiving the signals;
determining the media sheet is wide when the media sheet travel distance is equal to the first distance; and
determining the media sheet is intermediate when the media sheet travel distance is equal to the second distance.

2. The method of claim 1, wherein receiving the reference location signal occurs before receiving the media width sensor signal.

3. The method of claim 1, wherein the step of receiving the reference location signal occurs after receiving the media width sensor signal.

4. The method of claim 1, wherein the step of receiving the media width sensor signal when the media sheet is either wide or intermediate comprises rotating a flag that extends outward from the shaft through a transmission path of a detector.

5. The method of claim 1, further comprising tracking a speed of the media sheet moving along the media path between the reference location and the media width sensor.

6. The method of claim 1, wherein receiving the reference location signal comprises moving the media sheet from an input tray and determining that the media sheet is at a predetermined location along the media path.

7. The method of claim 1, determining that the media sheet contacted a third paddle that extends from the shaft and is positioned along the media path between the first and second paddles and determining the width of the media sheet is between the intermediate and wide widths.

8. A method of determining a width of a media sheet moving along a media path of an image forming apparatus with a media width sensor that includes a shaft with an upstream paddle and a downstream paddle, the method comprising:
receiving a sensor signal indicating the media sheet is at a first position along the media path;
determining the media sheet is narrow after failing to receive a media width sensor signal;
receiving the media width sensor signal indicating the media sheet is at the media width sensor, the media width sensor signal indicating that the media sheet is in contact with one of the upstream paddle and the downstream paddle;
determining a distance the media sheet traveled along the media path between the signals;
determining the media sheet is wide when the distance is substantially equal to a first distance between the first position and one of the upstream and downstream paddles; and
determining the media sheet is intermediate when the distance is substantially equal to a second distance between the first position and the other of the upstream and downstream paddles.

9. The method of claim 8, further comprising positioning the downstream paddle in closer proximity to a reference location on the media path than the upstream paddle.

10. The method of claim 8, wherein the step of receiving the sensor signal indicating the media sheet is at the first position along the media path comprises moving the media sheet through a sensor positioned along the media path.

11. The method of claim 8, wherein the step of receiving the sensor signal occurs before the step of receiving the media width sensor signal from the media width sensor.

12. The method of claim 8, wherein the step of receiving the sensor signal occurs after the step of receiving the media width sensor signal from the media width sensor.

13. The method of claim 8, wherein the step receiving the sensor signal indicating the media sheet is at the first position along the media path comprises tracking the media sheet moving along the media path and determining the media sheet is at a predetermined position along the media path.

14. The method of claim 8, further comprising determining the media sheet is a predetermined width between the wide and intermediate widths when the distance is substantially equal to a third distance between the first position and a third paddle positioned along the media path between the upstream and downstream paddles.

15. A method of detecting narrow, intermediate, and wide media widths comprising:
configuring a media width sensor in a media path such that it trips earlier, later, or not at all, depending on whether a given media sheet traveling along the media path is wide, intermediate, or narrow;
configuring a reference sensor in the media path to trip uniformly for narrow, intermediate and wide media sheets and positioning the reference sensor a known distance upstream or downstream of the media width sensor;
determining that the given media sheet is intermediate or wide based on evaluating a time interval between tripping of the media width sensor by the given media sheet and tripping of the reference sensor by the given media sheet; and
determining that the given media sheet is narrow based on tripping of the reference sensor in the absence of tripping the media width sensor.

16. The method of claim 15, wherein the step of determining that the given media sheet is narrow based on tripping of the reference sensor in the absence of tripping the media width sensor comprises moving the media sheet along the media path and between a gap formed between a reference edge and a paddle that extends from shaft on the media width sensor.

17. The method of claim 15, further comprising tracking a distance the media sheet moves along the media path between the first sensor and the media width sensor.

18. The method of claim 15, wherein the step of configuring the media width sensor in the media path such that it trips earlier, later, or not at all, depending on whether the given media sheet traveling along the media path is wide, intermediate, or narrow comprises contacting the media sheet with a first paddle positioned away from a reference edge when the media sheet is wide and contacting the media sheet with a second paddle positioned in closer proximity to the reference edge when the media sheet is intermediate.

19. The method of claim 18, further comprising rotating a flag that is operatively connected to the first and second paddles through a transmission path of a detector.

20. The method of claim 15, further comprising aligning the media sheet along a reference location within a center of the media path while moving the media sheet along the media path.
